(19) United States
(12) Patent Application Publication
(10) Pub. No.: US 2014/0132094 A1
(43) Pub. Date: May 15, 2014

(54) THERMAL MANAGEMENT OF AN IPM MOTOR WITH NON-MAGNETIC BARS

(71) Applicant: REMY TECHNOLOGIES, LLC, Pendleton, IN (US)

(72) Inventors: Bradley D. Chamberlin, Pendleton, IN (US); Colin Hamer, Noblesville, IN (US); Alex Creviston, Muncie, IN (US); Koon Hoong Wan, Fishers, IN (US)

(73) Assignee: Remy Technologies, LLC, Pendleton, IN (US)

(21) Appl. No.: 13/673,234

(22) Filed: Nov. 9, 2012

(51) Int. Cl. H02K 9/22; H02K 15/03

(52) U.S. Cl. CPC H02K 9/22; H02K 15/03
USPC 310/52; 29/598

(57) ABSTRACT

A rotor of an electric machine includes a lamination stack having a plurality of longitudinally extending magnet channels each having a magnet space and longitudinally extending gaps on each lateral end of the magnet space. A plurality of permanent magnets are respectively disposed in ones of the magnet channels, substantially non-magnetic bars are disposed in each longitudinally extending gap, and a thermally conductive filler material secures the magnets and the bars within the channels. A method of thermal management of an internal permanent magnet (IPM) rotor includes installing, into at least one longitudinally extending magnet channel of a lamination stack, a pair of substantially non-magnetic bars adjacent opposite lateral ends of a longitudinally extending permanent magnet, and transferring heat from the magnet through the bars into the lamination stack.

### BACKGROUND

The present invention is directed generally to improving the performance and efficiency of an internal permanent magnet (IPM) type motor/generator and, more particularly, to the transfer of heat from permanent magnets of a rotor.

The use of permanent magnets generally improves performance and efficiency of electric machines. For example, an IPM type machine has magnetic torque and reluctance torque with high torque density, and generally provides constant power output over a wide range of operating conditions. An IPM electric machine generally operates with low torque ripple and low audible noise. The permanent magnets may be placed on the outer perimeter of the machine's rotor (e.g., surface mount) or in an interior portion thereof (i.e., interior permanent magnet, IPM). IPM electric machines may be employed in hybrid or all electric vehicles, for example operating as a generator when the vehicle is braking and as a motor when the vehicle is accelerating. Other applications may employ IPM electrical machines exclusively as motors, for example powering construction and agricultural machinery. An IPM electric machine may be used exclusively as a generator, such as for supplying portable electricity.

Rotor cores of IPM electrical machines are commonly manufactured by stamping and stacking a large number of sheet metal laminations. In one common form, these rotor cores are provided with axially extending slots for receiving permanent magnets. The magnet slots are typically located near the rotor surface facing the stator. Motor efficiency is generally improved by minimizing the distance between the rotor magnets and the stator. Various methods have been used to install permanent magnets in the magnet slots of the rotor. These methods may either leave a void space within the magnet slot after installation of the magnet or completely fill the magnet slot.

Axially or longitudinally extending magnet channels are formed by magnet slots of laminations being stacked and aligned on top of one another. A permanent magnet may be positioned within a magnet slot so that, for example, the cross-sectionally long sides of the magnet are proximate the long sides of the magnet slot and gaps are formed between the cross-sectionally short sides of the magnet and the respective lateral ends of the magnet slot. One conventional practice includes injection molding a nylon type material into the openings/voids on either lateral end of a permanent magnet. Typically, such openings are specifically designed to help concentrate the magnetic flux in the rotor and thereby optimize performance of the electric machine.

One source of heat in IPM electric machines is the permanent magnets within the rotor. Typical design of magnet slots includes a matching profile in the magnetizing direction and a circular or curved profile in the non-magnetizing direction, and this basic design concept directs the flux path effectively and efficiently. However, thermal management is critical in the spaces surrounding permanent magnets because the magnets are sensitive to heat and will de-magnetize when subjected to excessive heat generated from power losses in the motor.

Conventional IPM rotors are not adequately cooled, resulting in lower machine efficiency and output, and excessive heat may result in demagnetization of permanent magnets and/or mechanical problems.

### SUMMARY

It is therefore desirable to obviate the above-mentioned disadvantages by providing improved structure for transferring heat away from permanent magnets of a rotor.

According to an exemplary embodiment, a rotor of an electric machine includes a lamination stack having a plurality of longitudinally extending magnet channels, each channel having therein a permanent magnet disposed between substantially non-magnetic bars, the bars having a thermal conductivity of at least 50 W/m·K. The rotor also includes a thermally conductive filler material securing the magnets and the bars within the channels.

According to another exemplary embodiment, a method of thermal management of an internal permanent magnet (IPM) rotor includes installing, into at least one longitudinally extending magnet channel of a lamination stack, a pair of substantially non-magnetic bars adjacent opposite lateral ends of a longitudinally extending permanent magnet, and transferring heat from the magnet through the bars into the lamination stack.

According to a further exemplary embodiment, an IPM rotor includes a lamination stack having a plurality of magnet channels each having a longitudinally extending permanent magnet and having longitudinally extending gaps on opposite lateral sides of the magnet, the magnet channels each having a pair of substantially parallel, non-radial sides. The IPM rotor also includes at least one substantially non-magnetic bar disposed in each gap.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic cross sectional view of an electric machine;

FIG. 2 is a perspective view of an interior permanent magnet (IPM) rotor of an electric machine;

FIG. 3 is a schematic view of a permanent magnet;

FIG. 4 is a top plan view of a lamination stack having ten sets of magnet slots, each set including four permanent magnets;

FIG. 5 is an enlarged view of one set of magnet slots containing permanent magnets and nonmagnetic bars, according to an exemplary embodiment;

FIG. 6 is a partial top plan view of a magnet and an adjacent nonmagnetic bar, according to an exemplary embodiment;

FIG. 7 is a top plan view of a permanent magnet fitted between two opposed nonmagnetic bars, according to an exemplary embodiment;

FIG. 8 is a top plan view of a magnet slot having a permanent magnet fitted between two opposed nonmagnetic bars, according to an exemplary embodiment;

FIG. 9 is a top plan view of a magnet slot having a permanent magnet and a plurality of nonmagnetic bars, according to an exemplary embodiment;

FIG. 10 is a partial cross-sectional view of a magnet slot of a rotor, the slot containing a group of nonmagnetic bars, according to an exemplary embodiment; and

FIG. 11 is a top plan view of a magnet slot of a rotor, the slot having a magnet and two nonmagnetic bars formed as springs for securing the magnet within the slot, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

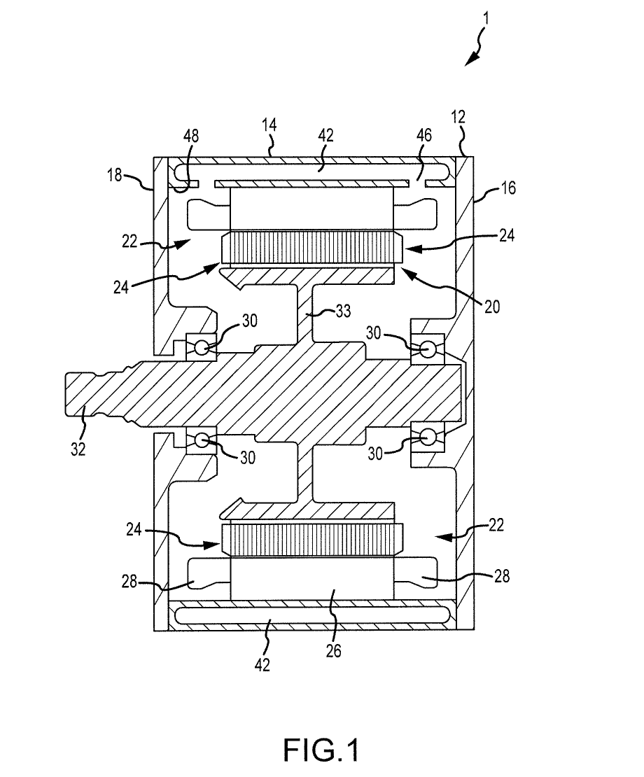

FIG. 1 is a schematic cross sectional view of an exemplary electric machine assembly 1. Electric machine assembly 1 may include a housing 12 that includes a sleeve member 14, a first end cap 16, and a second end cap 18. An electric machine 20 is housed within a machine cavity 22 at least partially defined by sleeve member 14 and end caps 16, 18. Electric machine 20 includes a rotor assembly 24, a stator assembly 26 including stator end turns 28, and bearings 30, and an output shaft 32 secured as part of rotor 24. Rotor 24 rotates within stator 26. Rotor assembly 24 is secured to shaft 32 by a rotor hub 33. In alternative embodiments, electric machine 20 may have a “hub-less” design.

In some embodiments, module housing 12 may include at least one coolant jacket 42, for example including passages within sleeve member 14 and stator 26. In various embodiments, coolant jacket 42 substantially circumscribes portions of stator assembly 26, including stator end turns 28. A suitable coolant may include transmission fluid, ethylene glycol, an ethylene glycol/water mixture, water, oil, motor oil, a gas, a mist, any combination thereof, or another substance. A cooling system may include nozzles (not shown) or the like for directing a coolant onto end turns 28. For example, coolant jacket apertures 46 may be positioned through portions of an inner wall 48 of sleeve member 14. After exiting coolant jacket apertures 46, the coolant may flow through portions of machine cavity 22 for cooling other components. The coolant may be pressurized when it enters the housing 12. After leaving housing 12, the coolant may flow through a heat transfer element (not shown) outside of housing 12 which removes the heat energy received by the coolant. The heat transfer element may be a radiator or a similar heat exchanger device capable of removing heat energy.

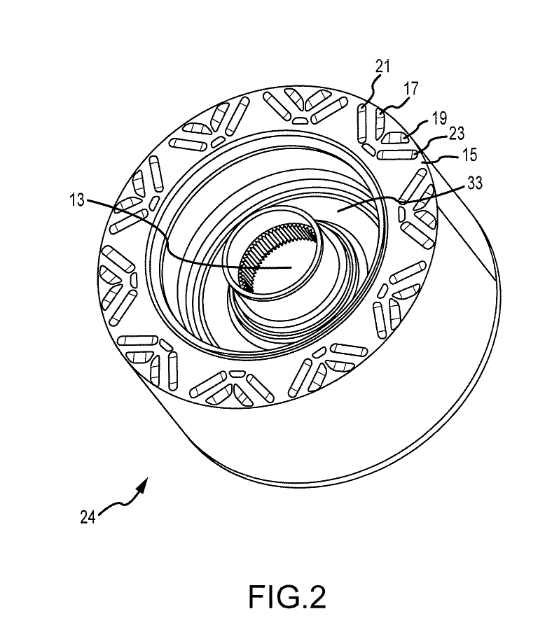

FIG. 2 is a perspective view of an IPM rotor 24 having a hub assembly 33 with a center aperture for securing rotor 24 to shaft 32. Rotor 24 includes a rotor core 15 that may be formed, for example, in a known manner as a stack of individual metal laminations made of steel or silicon steel. Rotor core 15 includes a plurality of axially-extending magnet slots 17, 19, 21, 23 each having an elongated shape, for example an elongated oval shape. In addition, although variously illustrated herein with sharp corners and ends, magnet slots 17, 19, 21, 23 typically have rounded ends for reducing stress concentrations in the rotor laminations. The example of FIG. 2 has ten sets of magnet slots, where each set includes magnet slots 17, 19, 21, 23, and where the sets define alternating poles (e.g., N-S-N-S, etc.) in a circumferential direction. Any appropriate number of magnet sets may be used for a given application. Magnet slots 17, 19, 21, 23 and corresponding magnets 2 may extend substantially the entire axial length of rotor core 15.

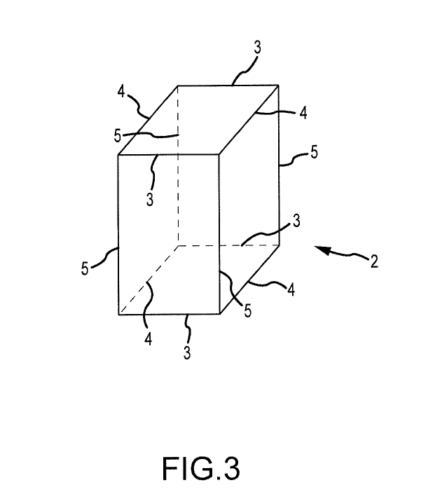

FIG. 3 shows an exemplary permanent magnet 2 formed as a rectangular column with a width defined as the linear dimension of any edge 3, a length defined as the linear dimension of any edge 4, and a height defined as a linear dimension of any edge 5. While a regular rectangular solid is described for ease of discussion, a permanent magnet of the various embodiments may have any appropriate shape. For example, magnets 2 may have rounded ends, sides, and/or corners. In another example, magnets 2 may be formed as a group of individual magnet pieces, such as by axially segmenting magnet 2 to allow for thermal expansion and other considerations. Respective areas bounded by edges 3, 4 may herein be referred to as magnet top and bottom. Respective areas bounded by edges 3, 5 may herein be referred to as magnet ends. Respective areas bounded by edges 4, 5 may herein be referred to as magnet lateral sides. Magnets 2 may have any appropriate size for being installed into the various magnet slots 17, 19, 21, 23. Magnets 2 are typically formed of rare-earth materials such as Nd (neodymium) that have a high magnetic flux density. Nd magnets may deteriorate and become demagnetized in the event that operating temperature is too high. When an electric machine is operating under a high temperature condition, the permanent magnets become overheated. For example, when a Nd magnet reaches approximately 320 degrees Celsius, it becomes demagnetized standing alone. When a combination of the temperature and the electric current of the machine becomes large, then demagnetization may also occur. For example, demagnetization may occur at a temperature of one hundred degrees C. and a current of two thousand amperes, or at a temperature of two hundred degrees C. and a current of two hundred amperes. As an electric machine is pushed to achieve greater performance, the increase in machine power consumption and associated power losses in the form of heat tests the stability of the magnets themselves. Therefore, it may be necessary to add Dy (dysprosium) to the magnet compound to increase the magnets' resistance to demagnetization. For example, a neodymium-iron-boron magnet may have up to six percent of the Nd replaced by Dy, thereby increasing coercivity and resilience of magnets 2. Although dysprosium may be utilized for preventing demagnetization of magnets 2, it is expensive, and the substitution of any filler for Nd reduces the nominal magnetic field strength. The Dy substitution may allow an electric machine to run hotter but with less relative magnetic field strength. Permanent magnets 2 can be formed of any hard magnetic material, including sintered NdFeB, bonded NdFeB, SmCo, Ferrite, and Alnico.

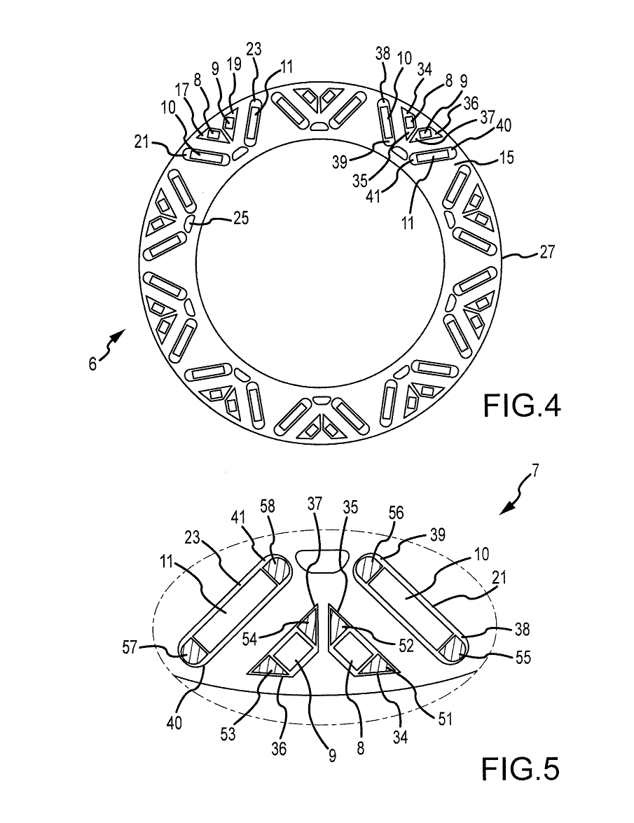

FIG. 4 is a top plan view of a rotor assembly 6 having ten substantially identical sets of magnet slots 17, 19, 21, 23. Although various ones of magnet slots 17, 19, 21, 23 are shown with sharp edges, such edges may be rounded. After a permanent magnet 8 has been placed into magnet slot 17, there are gaps 34, 35 between the magnet 8 ends and the interior wall of slot 17. Similarly, after a permanent magnet 9 has been placed into magnet slot 19, there are gaps 36, 37 between the magnet 9 ends and the interior wall of slot 19. After a permanent magnet 10 has been placed into magnet slot 21, there are gaps 38, 39 between the magnet 10 ends and the interior wall of slot 21. After a permanent magnet 11 has been placed into magnet slot 23, there are gaps 40, 41 between the magnet ends and the interior wall of slot 23. Gaps 34-41 prevent a short-circuiting of magnetic flux when a direction of magnetization of respective ones of magnets is orthogonal to the magnet ends. When the magnet slots are located very close to the rotor exterior to maximize motor efficiency, only a thin bridge of rotor core material formed by the stacked laminations of the rotor separates magnet slots 17, 19, 21, 23 from the exterior surface 27 of the rotor.

FIG. 5 is an enlarged partial top view of rotor assembly 6, showing one set of magnet slots 17, 19, 21, 23. Non-magnetic bars 51-58 are correspondingly placed into gaps 34-41 and extend longitudinally through rotor core 15. Bars 51-58 may each be formed of a single piece or of multiple pieces of non-magnetic material such as aluminum, copper, lead, gold, silver, or other material having a high thermal conductivity. For example, a suitable grade of aluminum has a thermal conductivity of approximately 210 W/mK. Bars 51-58 may each have a shape that substantially matches the shape of a portion of a corresponding one of gaps 34-41. In such a case, a rotor assembly 6 may be assembled, for example, by heating rotor core 15 to a high temperature and cooling bars 51-58 to a low temperature prior to installing bars 51-58 into gaps 34-41, whereby the subsequent warming of assembly 6 causes bars 51-58 to be tightly fit. For example, when rotor core is heated to 200° C. and bars 51-58, formed of 7 mm thick aluminum, are cooled to about −180° C., a gap of approximately 50 microns may thereby be created, allowing easy alignment. Subsequent heating of rotor assembly 6 causes rotor core 15 and bars 51-58 to compress against the magnets and against one another to improve heat transfer. In another exemplary embodiment, bars 51-58 may be installed into gaps 34-41 as loose pieces of non-magnetic material, and assembly may include injecting resin, nylon, or other suitable thermally conductive material into magnet slots 17, 19, 21, 23 to form an integral structure. The time and pressure of the injection, and the viscosity of the injected material may be adjusted to assure that no air is trapped within. Bars 51-58 may be malleable, whereby they may be pressed or impacted into gaps 34-41. Bars 51-58 may contain channels or be formed with surfaces to allow injected material to freely flow therethrough. In an exemplary embodiment, bars 51-58 may be formed by injecting liquid metal such as Tin, Aluminum, or Zinc into magnet slots 17, 19, 21, 23 and then allowing the metal to solidify by cooling. In another exemplary embodiment, bars 51-58 may be at least partially coated with a thermally conductive adhesive that is cured after assembly.

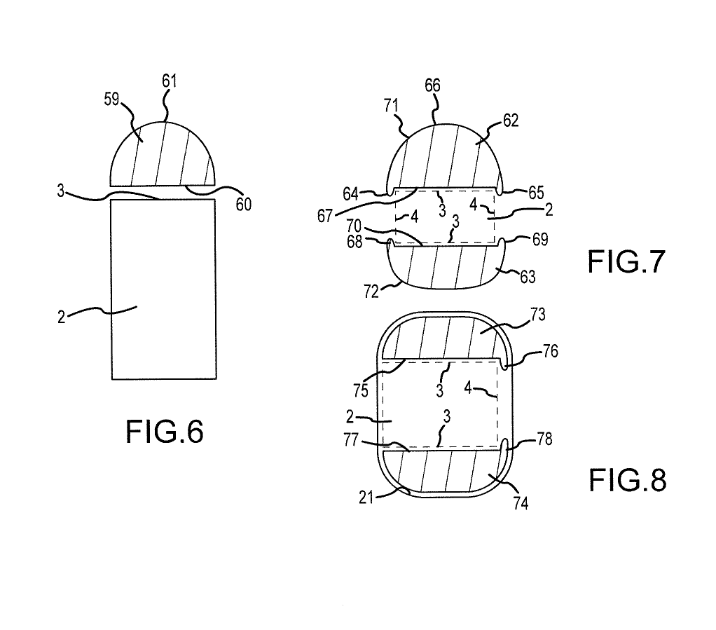

FIG. 6 is a top plan view of a non-magnetic bar 59 having a substantially flat surface 60 for contiguous abutment with an end 3 of magnet 2. By maintaining a maximum amount of contacting surface area between bar 59 and magnet 2, the corresponding heat transfer from magnet 2 may be optimized. Bar 59 has a curved outer surface 61 that may have a same shape as a corresponding surface of one of gaps 34-41, whereby heat transfer may be optimized between bar 59 and rotor core 15.

FIG. 7 is a top plan view of non-magnetic bars 62, 63 placed into abutment with a permanent magnet 2. Portions of bar 62 are formed with end stops 64, 65 that abut respective surfaces 4 of magnet 2 for positioning and preventing lateral movement of magnet 2. End stops 64, 65 may be formed so that an injected resin or other supporting material may easily flow within a magnet slot to assure the removal of air. For example, end stops 64, 65 may be formed only at axial ends of rotor core 15, whereby injected material is not axially impeded. The axial ends of bar 62 may be slanted toward longitudinal end 66, whereby any offset between magnet 2 and bar 62 caused by abutment of magnet end surface 3 with end stops 64, 65 does not cause an excessive space between the axially extending portions of magnet 2 and the inward facing surface 67 of bar 62. In some applications, such a space between magnet 2 and surface 67 may be desirable and, if so, end stops 64, 65 may be formed with respective magnet resting portions for offsetting magnet 2 away from surface 67. For example, when air must be replaced by injected resin or other material, it may be desirable to provide sufficient space for the material to avoid the possibility of trapping air. Non-magnetic bar 63 is formed with end stops 68, 69 for securing, positioning, and/or offsetting the longitudinally opposite end of magnet 2 in the same manner as described for bar 62. For example, axially extending surface 70 of bar 63 may be offset from or placed into abutment with the adjacent magnet surface 3, depending on the lateral distance between end stops 68, 69. Respective outer surfaces 71, 72 of bars 62, 63 may be formed with shapes substantially the same as the respective shapes of a corresponding magnet slot to maximize abutment or the shapes of surfaces 71, 72 may be different from the shape(s) of the adjacent walls of a magnet slot, for example including channel portions for forcing air out of the assembly during injection of a binding material.

FIG. 8 is a top plan view of non-magnetic bars 73, 74 placed into abutment with a permanent magnet 2 within a magnet slot 21. Bar 73 has a magnet contacting surface 75 and an end stop 76 protruding from surface 75, and bar 74 has a magnet contacting surface 77 and an end stop 78 protruding from surface 77. When bars 73, 74 and magnet 2 are installed in magnet slot 21, surfaces 75, 77 are in substantial contact with opposite magnet ends 3, whereby a maximum amount of surface area for contacting allows for optimum heat transfer from magnet 2. End stops 76, 78 contact magnet side 4, allowing magnet 2 to be accurately positioned, where side 4 may be offset from an adjacent wall of magnet slot 21 to assure that an injected thermally conductive material fills the space without trapping any air. When the structure is assembled with non-magnetic bars 73, 74 in a cold state (e.g., −180 degrees C.), magnet 2 may be accurately positioned by subsequent expansion of bars 73, 74 that results in bars 73, 74 being securely held in place by self-tension against magnet 2 and magnet slot 21.

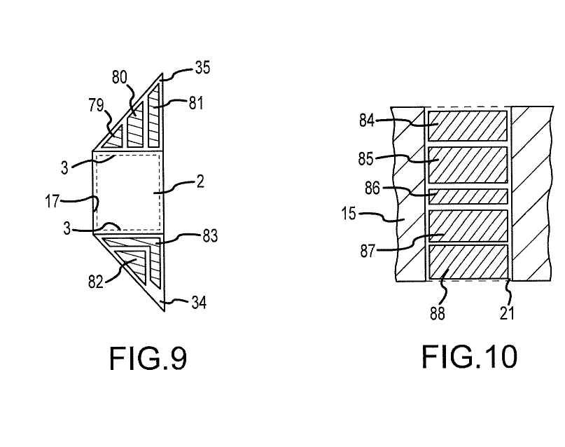

FIG. 9 is a top plan view of a magnet slot 17 containing a magnet 2. Non-magnetic bars 79, 80, 81 are installed in gap 35, and non-magnetic bars 82, 83 are installed in gap 34. Bars 79-83 may have regular, defined shapes or they may be randomly shaped pieces. In the former case, bars 79-83 may be designed to provide heat transfer from magnet ends 3 in a specific route to particular portions of a surrounding rotor core 15. For example, bar 83 may act to contact substantially an entire adjacent magnet wall 3 and transfer heat by also contacting a specific part of a wall of magnet slot 17. By segmenting the non-magnetic bars, installation and/or magnet positioning may be optimized to assure proper heat transfer, elimination of trapped air during injection of filler material, balancing or weight distribution, and/or use of different materials. For example, a combination of materials may include aluminum and carbon fiber.

FIG. 10 is a partial side cross-sectional view of a magnet slot 21 having a non-magnetic bar formed as a series of individual bars 84-88 stacked on top of one another. The stack of non-magnetic bars may be substituted for a single bar of other embodiments, for example the stack may replace any of bars 55-58. For example, the stack of non-magnetic bars may be placed into abutment with a side 3 of magnet 2. In general the thermal expansion of non-magnetic bars may be different than that of surrounding materials. When a given structure becomes long, the effects of such expansion, and contraction, become relatively greater. To compensate for thermal expansion, the longitudinal structure of a non-magnetic bar is broken into bars 84-88. The spaces between ones of bars 84-88 may be filled with thermally conductive material. For example, any of bars 84-88 may have projecting portions that provide a respective defined gap between adjacent one of bars 84-88. Such gap may be implemented to assure that filler material is able to flow and fully encapsulate individual bars 84-88 and/or magnet 2, whereby air is completely removed. The exemplary embodiment of segmented bars may be subject to various limitations, such as the creation of a loose and less effective structure that requires a thorough analysis of the expansion of thermally conductive material being placed between the segmented pieces. Typically, the best thermal conductivity, thermal transfer, and mechanical integrity are achieved by use of single-piece rather than segmented bars. However, segmented portions may be used, for example, when a magnet slot has a geometry that precludes the use of a single bar.

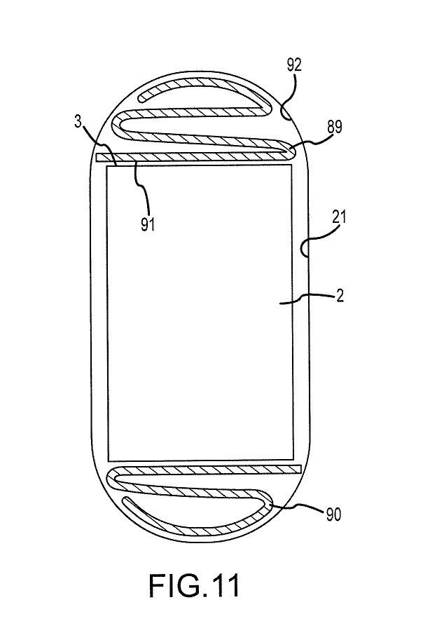

FIG. 11 is a top plan view of a magnet slot 21 containing a magnet 2. Non-magnetic bars 89, 90 are each formed as a spring. In this exemplary embodiment, bar 89 has a substantially flat portion 91 that extends longitudinally to provide a high degree of abutment between flat surface 91 and magnet side 3. Bar 89 is compressed for installation and then self-biases between magnet 2 and an inside surface 92 of magnet slot 21. When the same or similar structure is used for forming bar 90, magnet 2 is securely held by urging of bars 89, 90. The composition of bars 89, 90 may be adjusted to provide suitable spring-like properties of the bar material. For example, brass or other non-magnetic material may be included. The illustrated embodiment shows how the surface area of a bar may be increased, and such increased surface area may allow for the optimization of heat transfer characteristics. For example, a hot bar may be isolated from a particular portion of a rotor core 15 by implementing a serpentine shape.

The composition and/or shape of non-magnetic bars may be tailored for a given application. For example, carbon fiber, nylon, or other fabric may be included as a filler or as a part of a non-magnetic bar. In a different embodiment, selected sections of a non-magnetic bar may include malleable portions that allow the bar to be form fit into a space. For example, when components of an assembly have been cooled to approximately minus forty degrees C. to allow assemblage, a subsequent heating may also include impacting, whereby a malleable surface is molded to have a same shape and be contiguous with an adjacent surface. In a different embodiment, a bar may have a malleable surface at the contact point with a magnet 2, so that the malleable surface secures the magnet in place. In such a case, the non-magnetic bar acts as an end stop that prevents movement of magnet 2. In a further embodiment, a softened material may be axially pressed to form a shape that completely fills gaps 34-41 (e.g., FIG. 5), or that is pressed to a shape that is supplemented by a subsequently injected material.

The differences in thermal expansion of the various components may be better accounted for by a modular construction. In particular, when the interfaces between a non-magnetic bar, a steel lamination, a magnet, and a thermally conductive filler are tight at room temperature, they become even tighter as they get hotter. Careful selection of shapes and materials prevents surfaces from becoming strained and yielding to pressure. The above-illustrated exemplary embodiments of FIGS. 9-11 may include segmenting of non-magnetic bars to provide ersatz expansion joints that minimize problems associated with differing rates of thermal expansion. The thermally conductive filler material may be compacted aluminized powder, which allows a magnet slot filled with a magnet and one or more bars to adjust more evenly to a variable volume created by thermal expansion. Alternatively, the thermally conductive filler may include an epoxy material or an epoxy mixed with alumina. In such a case, non-magnetic bars may be inserted into the epoxy. For example, magnets 2 may be inserted into a rotor core, and then magnet slots 34-41 may be partially filled with epoxy. Non-magnetic bars may then be dropped into slots 34-41, where each such bar may be formed as small pellets, segmented metal bars, a single bar, a single bar with strain relief cuts in it, one or more spring-like bars, fabric bars, and others. In another exemplary embodiment, non-magnetic bars are formed using an extrusion dye so that the bars have substantially the same shape as the corresponding gaps 34-41 and are simply pressed into position, such as when cooled to minus forty degrees C.

Thermally conductive, nonmagnetic material may include a synthetic resin such as a polyphenylene sulfide resin, nylon, alumina, epoxy, powder, thermoset, or others. Processing may include any number of heating and cooling cycles, such as for curing, softening, hardening, molding, shaping, forging, extruding, melting, and installing any structure. Removal of excess material may be performed in conjunction with any process. For example, trimming a rotor outside diameter and/or rotor balancing may include removal of some material of rotor core 15, nonmagnetic bars 51-58, and filler material.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A rotor of an electric machine, comprising:
a lamination stack having a plurality of longitudinally extending magnet channels, each channel having therein a permanent magnet disposed between substantially non-magnetic bars, the bars having a thermal conductivity of at least 50 W/m·K; and
a thermally conductive filler material securing the magnets and the bars within the channels.

2. The rotor of claim 1, wherein the bars comprise aluminum.

3. The rotor of claim 1, wherein the magnets and bars are grouped symmetrically as sets about respective radii of the lamination stack.

4. The rotor of claim 1, wherein the bars abut the magnets.

5. The rotor of claim 1, wherein the magnet channels each include at least two edge support projections for preventing lateral movement of the respective magnet.

6. The rotor of claim 1, wherein the bars have a thermal conductivity of at least 200 W/m·K.

7. A method of thermal management of an internal permanent magnet (IPM) rotor, comprising:
installing, into at least one longitudinally extending magnet channel of a lamination stack, a pair of substantially non-magnetic bars adjacent opposite lateral ends of a longitudinally extending permanent magnet; and
transferring heat from the magnet through the bars into the lamination stack.

8. The method of claim 7, further comprising injecting a thermally conductive filler material into the magnet channel for securing the magnet and the bars thereto.

9. The method of claim 7, wherein the bars abut the magnet.

10. The method of claim 7, wherein the magnet is substantially rectangular and the bars each have a substantially flat longitudinally extending surface, and wherein the installing comprises placing the flat surfaces of the bars into substantially contiguous abutment with respective ones of the opposite lateral ends of the magnet.

11. The method of claim 7, wherein the magnet channel includes at least two edge support projections, the method further comprising securing the magnet between the two edge support projections.

12. The method of claim 11, wherein the installing comprises placing the bars into abutment with respective ones of the edge support projections.

13. An IPM rotor, comprising:
a lamination stack having a plurality of magnet channels each having a longitudinally extending permanent magnet and having longitudinally extending gaps on opposite lateral sides of the magnet, the magnet channels each having a pair of substantially parallel, non-radial sides; and
at least one substantially non-magnetic bar disposed in each gap.

14. The rotor of claim 13, wherein the bars are formed of pellets.

15. The rotor of claim 14, wherein the bars are segmented to include expansion joints between adjacent segments.

16. The rotor of claim 13, wherein the bars have a thermal conductivity of at least 200 W/m·K.

17. The rotor of claim 13, further comprising a thermally conductive filler material securing the magnets and the bars within the channels.

18. The rotor of claim 17, wherein the magnets are substantially encapsulated by the bars and filler material.

19. The rotor of claim 13, wherein the bars are formed as springs for biasing the respective magnets.

20. The rotor of claim 13, wherein the bars bias respective surfaces of the magnet channels.
